(19) United States
(12) Patent Application Publication
(10) Pub. No.: US 2007/0097143 A1
(43) Pub. Date: May 3, 2007

(54) Application of variable opacity (image alpha) to power and probability distributions superimposed on cartographic displays

(76) Inventors: Mutsuya Ii, Shoreline, WA (US); Robert T. Cutler, Everett, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/261,208

(22) Filed: Oct. 28, 2005

(51) Int. Cl. G09G 5/02

(52) U.S. Cl. 345/592

(57) ABSTRACT

A system and method are disclosed for superimposing data on an image using a variable opacity that is based upon variations in the numerical values of the data to be superimposed. This allows for representing data most prominently where it the values are higher, while still providing a clear view of the surrounding features.

### CROSS-REFERENCE TO RELATED APPLICATIONS

This application is related to co-pending and commonly assigned U.S. patent application Ser. No. 11/114,314 entitled “METHOD AND SYSTEM FOR COMPUTING AND DISPLAYING LOCATION INFORMATION FROM CROSS-CORRELATION DATA,” filed Apr. 25, 2005, and co-pending and commonly assigned U.S. patent application Ser. No. 11/114,759 entitled “METHOD AND SYSTEM FOR EVALUATING AND OPTIMIZING RF RECEIVER LOCATIONS IN A RECEIVER SYSTEM,” filed Apr. 2, 2005, all of the disclosures of which are hereby incorporated herein by reference.

### TECHNICAL FIELD

The present invention is directed generally to superimposing data on images, and more particularly to superimposing probability density functions or power distributions on cartographic displays.

### BACKGROUND OF THE INVENTION

In certain geolocation applications, it is often useful to superimpose data, such as a probability data, power distribution, density data, or other data, on a cartographic display, such as a map. This allows representation of the probability that a certain feature is present at certain locations represented by the map, the amount of power that is present at certain locations represented by the map, or the densities of some element at certain locations represented by the map.

When forming the display, there is a trade-off between the visibility of the superimposed data and the underlying map. The superposition will use an alpha or opacity factor to determine the relative transparency of the superimposed data. An opacity of 0.0 will result in the underlying map being completely visible and the superimposed data being invisible. An opacity of 1.0 will result in the underlying map being obscured and the superimposed data being completely visible.

If the opacity is set too low, the superimposed data will be difficult to see. If the opacity is set too high, the features in the underlying map will be difficult to discern. Previously, applications would use a single opacity value for the entire data set that provided a compromise between the visibility of the data and the underlying map. When such arrangements are used in power distributions superimposed on maps, for example, regions of the map with little to no power would be obscured by the superimposed data to the same extent as regions with maximum power.

Superimposing data on an image requires a number of steps. The data may often be represented using a color scheme, with a color scale selected to span the range of data values. The data also needs to be registered to the map, as the data will generally represent the values of some quantity at specific locations. When using a map, for example, the superimposed data should be aligned and scaled to coincide with the map so that the location represented by a specific superimposed data value corresponds to the same location as represented on the map at the point of overlay. To superimpose the data, the map image and the color scheme representing the data are combined. An opacity factor determines the relative weight by which the color representing the data obscures the map.

### BRIEF SUMMARY OF THE INVENTION

Representative embodiments of the present invention provide for varying the opacity based upon variations in the numerical values of the data being superimposed on a chart. This allows for representing the superimposed data most prominently where the values are the highest, and viewing the underlying chart more prominently where the superimposed data values are the lowest. That is, the opacity may be higher for higher data values, and lower for lower data values. Such a variation allows for using a higher opacity to see clearly where data values are the highest, while still providing a clear view of the surrounding chart features. Other embodiments of the invention allow for an inverse relationship between opacity and data values, and/or non-linear relationships.

Representative embodiments of the present invention provide for varying the opacity based upon variations in the numerical values of the data to be overlaid. This allows for representing the power or probability most prominently where it is strongest, and viewing the underlying map more prominently where probability or power is weakest. That is, the opacity may be higher for higher data values, and lower for lower data values. Such a variation allows for using a higher opacity to see clearly where power or probability is strongest, while still providing a clear view of the surrounding landmarks and other map annotations. Other embodiments of the invention allow for an inverse relationship between opacity and data values, and/or non-linear relationships.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a plot of opacity versus normalized power/probability values;

FIG. 2 shows an alternative plot of opacity versus normalized power/probability values;

FIG. 3 shows an overlay of a map with a power density superimposed using a constant alpha or opacity of 0.95;

FIG. 4 shows an overlay of a map with a power density superimposed using a constant opacity of 0.35;

FIG. 5 shows an overlay of a map with a power density superimposed using a varying opacity ranging up to a maximum of 0.95;

FIG. 6 shows an overlay of a map with a power density superimposed using a varying opacity ranging up to a maximum of 0.60; and

FIG. 7 depicts a block diagram of a computer system which is adapted to use the present invention.

### DETAILED DESCRIPTION OF THE INVENTION

It will be understood that the inventive concepts of the present invention may be adapted for use to superimpose data of any type related to an underlying chart or map. What follows will be understood to be specific embodiments, and the present invention need not be limited to only the embodiments described.

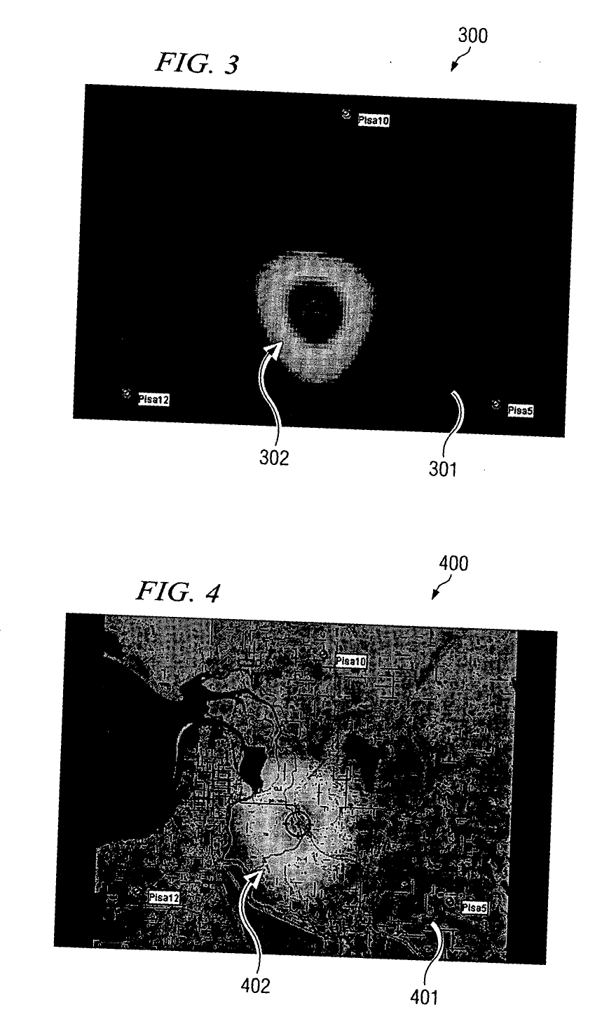

FIG. 3 shows overlay 300 of map 301 with power density 302 superimposed using a constant alpha or opacity of 0.95. Power density 302 is easily seen, however features of map 301 are obscured.

FIG. 4 shows overlay 400 of map 401 with power density 402 superimposed using a constant opacity of 0.35. The features of map 401 are easily seen, but the color intensity of power density 402 is compromised.

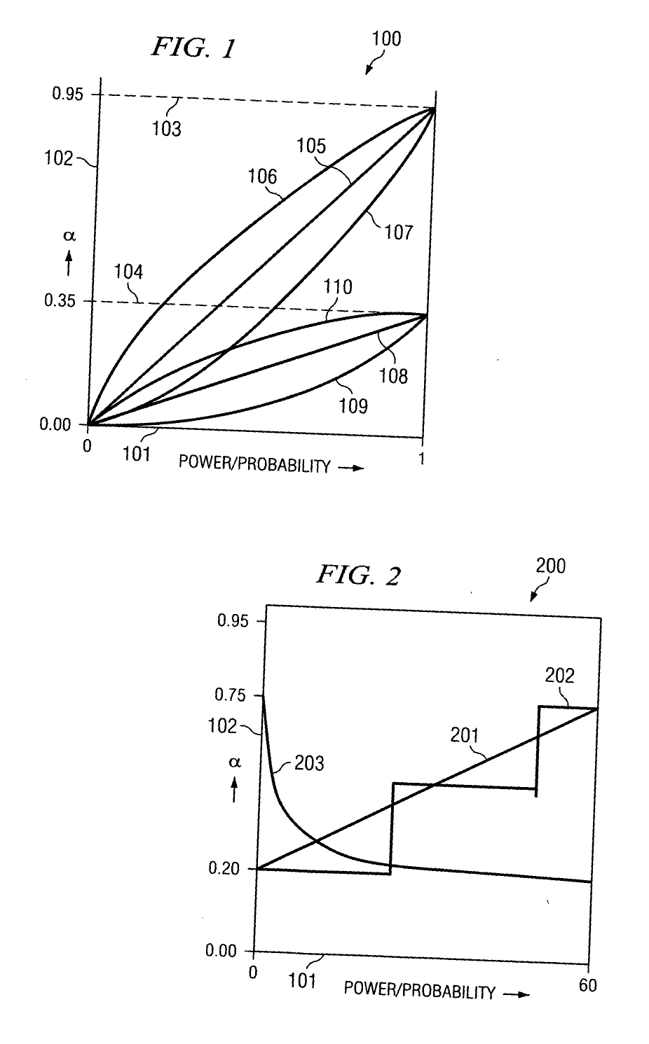

FIG. 1 shows plot 100 of opacity versus normalized power/probability values. Power/probability axis 101 shows values from 0.0 to 1.0, which represent the extremes of normalized data values. Alpha axis 102 shows values from 0.0 to 0.95 which represent the range from invisibility to near total obscuration by the superimposed data. Line 103 represents a constant opacity value of 0.95 as used in overlay 300 of FIG. 3. Line 104 represents a constant opacity value of 0.35 as used in overlay 400 of FIG. 4. Note than in lines 103 and 104, opacity is constant for all values of power/probability.

Line 105 shows a variation of opacity with power/probability. Line 105 shows a linear variation starting at an opacity of 0.0 for power/probability of 0.0 and increasing to a maximum opacity of 0.95 for a power/probability of 1.0. Note that in FIG. 1, the power/probability values are normalized to a minimum of 0.0 and a maximum of 1.0. Lines 106 and 107 show examples of non-linear alternatives for line 105. The non-linear functional relationship between power/probability and opacity may be logarithmic, exponential, polynomial, discrete steps, Fibonacci, factorial, sinusoidal, or any other suitable function. As another example, line 108 shows a variation of opacity with power/probability up to a maximum opacity of 0.35. Lines 109 and 110 represent examples of non-linear alternatives to line 108. In some situations, it may be desirable to use an inverse relationship between opacity and power/probability. Each of the different lines represents an example functional relationship between opacity and power/probability that can be used for determining opacity in an overlay.

FIG. 2 shows alternative plot 200 of opacity versus normalized power/probability values. Power/probability axis 101 shows values from 0.0 to 1.0, which represent the extremes of normalized data values. Alpha axis 102 shows values from 0.0 to 0.95 which represent the range from invisibility to near total obscuration by the superimposed data.

Line 201 represents a variable opacity with a minimum opacity above 0.0 when the power/probability is at a minimum value. Line 202 represents a stepped opacity, with a number of discrete values covering various ranges of power/probability. Line 203 represents an inverse relationship between opacity and power/probability, shown here as an exponential decay.

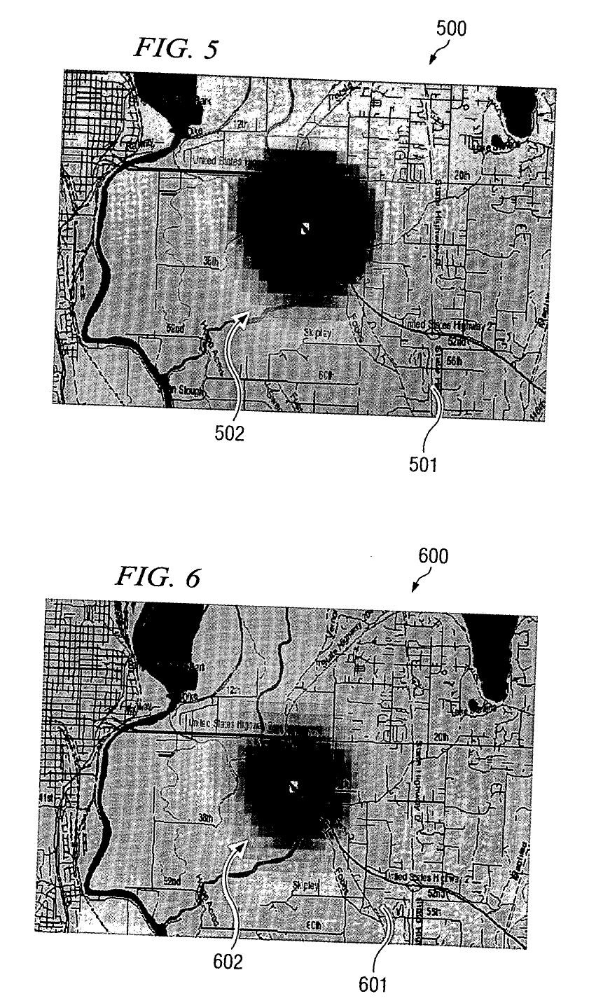

FIG. 5 shows overlay 500 of map 501 with power density 502 superimposed using a varying opacity ranging up to a maximum of 0.95. In FIG. 4, both the highest regions of power density 502 are clearly visible, as well as the features of map 501 in the regions of lower power.

FIG. 6 shows overlay 600 of map 601 with power density 602 superimposed using a varying opacity ranging up to a maximum of 0.60. Not only can the functional relationship between opacity and power/probability be tailored, but the maximum and minimum opacity can also be adapted to maximize the clarity of the information in the display.

Note that any of the functions described herein may be implemented in hardware, software, and/or firmware, and/or any combination thereof. When implemented in software, the elements of the present invention are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

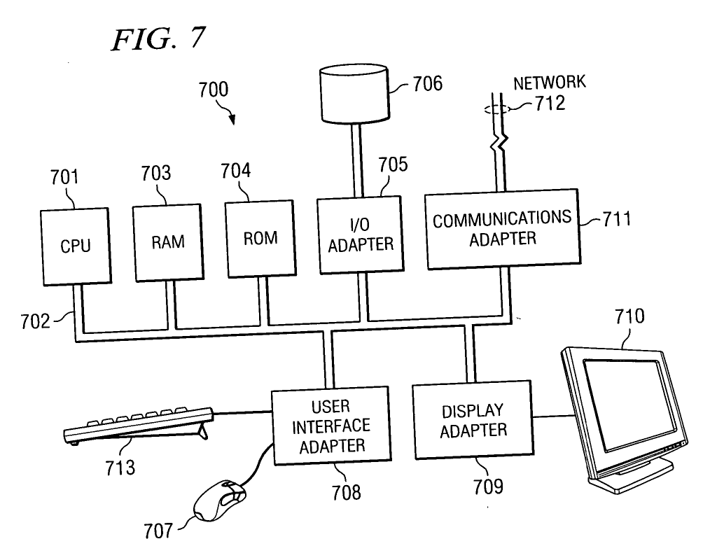

FIG. 7 illustrates computer system 700 adapted to use the present invention. Central processing unit (CPU) 701 is coupled to system bus 702. The CPU 701 may be any general purpose CPU, such as an HP PA-8500 or Intel Pentium processor. However, the present invention is not restricted by the architecture of CPU 701 as long as CPU 701 supports the inventive operations as described herein. Bfs 702 is coupled to random access memory (RAM) 703, which may be SRAM, DRAM, or SDRAM. ROM 704 is also coupled to bus 702, which may be PROM, EPROM, or EEPROM. RAM 703 and ROM 704 hold user and system data and programs as is well known in the art.

Bus 702 is also coupled to input/output (I/O) controller card 705, communications adapter card 711, user interface card 708, and display card 709. The I/O adapter card 705 connects to storage devices 706, such as one or more of a hard drive, a CD drive, a floppy disk drive, a tape drive, to the computer system. The I/O adapter 705 is also connected to printer 714, which would allow the system to print paper copies of information such as document, photographs, articles, etc. Note that the printer may a printer (e.g. dot matrix, laser, etc.), a fax machine, or a copier machine. Communications card 711 is adapted to couple the computer system 700 to a network 712, which may be one or more of a telephone network, a local (LAN) and/or a wide-area (WAN) network, an Ethernet network, and/or the Internet network. User interface card 708 couples user input devices, such as keyboard 713, pointing device 707, and microphone 716, to the computer system 700. User interface card 708 also provides sound output to a user via speaker(s) 715. The display card 709 is driven by CPU 701 to control the display on display device 710.

The overlays may be viewed on a display, such as a computer display device 710, or printed on any suitable medium. The color scale used for representing data values may either be true color or a grayscale. Examples of uses include display of the location of an emitter, such as a signal transmitter device, denoted by varying shades of color using the “Tentagram” display format as described in U.S. patent application Ser. No. 11/114,759 entitled “METHOD AND SYSTEM FOR COMPUTING AND DISPLAYING LOCATION INFORMATION FROM CROSS-CORRELATION DATA,” the disclosure of which is hereby incorporated herein by reference. Other examples of uses include, without limitation, displays of transmitter geolocation, transmitter power densities, acoustic sonar data, weather data, radiation distribution, particulate distribution, particle density, energy distribution, and lightning strike location.

The data to be superimposed may include multi-modal distributions which contain multiple regions of relatively high and low values, rather than just a single region of high values. Further, the shape of the distribution contours may be significantly different than circular, such as dog-bone shaped. The underlying image need not be a map, but may be any image suitable for an overlay of data. Examples include, without limitation, representations of objects, schematics of circuits, drawings of devices, photographs of scenes and medical images. The data may be supplied as a data file, or an attached system may furnish measurements. Likewise, the image may be supplied as a pre-existing image or may be collected using an attached system. The overlaying can be accomplished by merging two separate files on a computer or by maintaining two separate files and visually combining the files.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of superimposing data on an image, said method comprising:
determining a color scale to represent numerical values of said data;
superimposing said data on said image using said color scale; and
varying the opacity of said superimposing based upon variations in said numerical values of said data.

2. The method of claim 1 further comprising:
setting a minimum opacity and a maximum opacity; and
scaling said opacity of said superimposing between said minimum opacity and said maximum opacity.

3. The method of claim 2 wherein said scaling of said opacity between said minimum opacity and said maximum opacity is a linear function.

4. The method of claim 2 wherein said scaling of said opacity between said minimum opacity and said maximum opacity is a non-linear function.

5. The method of claim 4 wherein said non-linear function is selected from the list comprising:
logarithmic, exponential, polynomial, discrete steps, Fibonacci, factorial, and sinusoidal.

6. The method of claim 1 wherein said image is a map.

7. The method of claim 1 wherein said data is probability data.

8. The method of claim 1 wherein said data is power distribution data.

9. The method of claim 1 wherein said data is density data.

10. The method of claim 1 wherein said data is related to at least one of:
transmitter location, transmitter power, acoustic data, sonar data, weather data, radiation distribution, particulate distribution, lightning strike location, energy distribution, and medical image data.

11. The method of claim 1 wherein said superimposing comprises registering said data to said image.

12. The method of claim 1 wherein said color scale is a grayscale.

13. The method of claim 1 wherein said color scale comprises non-grayscale colors.

14. The method of claim 1 wherein said data is multi-modal.

15. A means for forming an overlay, wherein an opacity of the overlay is varied to represent variations in the numerical values of the data, said means comprising:
means for obtaining data;
means for obtaining an underlying image; and
means for overlaying said data on said image.

16. The means of claim 15 wherein said opacity varies between a minimum value and a maximum value.

17. The means of claim 16 wherein said variation of opacity is linearly dependent on said numerical values.

18. The means of claim 16 wherein said variation of opacity is non- linearly dependent on said numerical values.

19. The means of claim 15 wherein said overlay provides geolocation information.

20. The means of claim 15 wherein said data is related to at least one of:
power density, probability, location, acoustic data, weather data, particle density, energy distribution, and medical image data.

21. A method of superimposing data on an image, comprising:
providing a plurality of numerical values of the data;
forming an overlay, wherein an opacity of the overlay is varied to represent variations in the numerical values of the data; and
superimposing the overlay on the image.

22. The method of claim 20 further comprising determining a color scale to represent said numerical values.

23. A visual representation of data comprising:
an image; and
a computer-generated overlay, wherein an opacity of the overlay is varied to represent variations in the data;
wherein the overlay is located above the image.

24. The visual representation of claim 23 wherein said overlay provides location information.
